(19) United States
(12) Patent Application Publication
(10) Pub. No.: US 2017/0010359 A1
(43) Pub. Date: Jan. 12, 2017

(54) GOLF DEVICE WITH GPS AND LASER RANGEFINDER FUNCTIONALITIES

(71) Applicant: DECA SYSTEM, INC., Seongnam-si (KR)

(72) Inventor: SEUNG WOOK JUNG, CERRITOS, CA (US)

(21) Appl. No.: 14/795,846

(22) Filed: Jul. 9, 2015

(51) Int. Cl. G01S 19/19; G06F 17/30; G01S 17/08; A63B 57/00; A63B 71/06

(52) U.S. Cl. CPC G01S 19/19; A63B 57/00; A63B 71/0619; G01S 17/08; G06F 17/30061

(57) ABSTRACT

The disclosure herein provides a golf device comprising a GPS module, a laser module, and an orientation module that collectively provide functionalities that facilitate the user of the golf device through a game of golf. The golf device further comprises one or more processors configured to communicate with the GPS module, the laser module, and the orientation module to determine the location of a visible target selected by a user, and to display the target's location on a plan view map representation of a hole comprising at least one feature such that the target's location relative to the at least one feature of the hole is graphically represented on the plan view map representation of the hole.

### BACKGROUND

With the development of new technologies, a golfer can use a golf GPS device to view the locations of the various features on a golf course with respect to the current location of the golfer. Further, the golfer can use a laser rangefinder to measure distances to visible objects on the golf course.

### SUMMARY

In one aspect, a golf device comprises a GPS module configured to receive GPS signals for determining a location of the golf device; a laser module configured to emit laser beams and detect reflections thereof from a target when the target is selected for determining a distance between the golf device and the target; an orientation module configured to monitor movement of the golf device for determining an orientation of the golf device when the golf device aims the target and laser beams are emitted to the target; an information display configured to display information thereon; data stored in a memory and for use in displaying map representation of a plurality of golf courses on the information display; and at least one processor. The processor is configured to perform a method of: determining the location of the golf device based on the GPS signals from the GPS module, determining the distance between the golf device and the target based on the laser module's emission of laser beams to the target and detection of their reflections from the target, determining the orientation of the golf device at the time of emission of laser beams to the target, computing target location information indicative of a location of the target using each of the determined location of the golf device, the determined distance between the golf device and the target, and the determined orientation of the golf device, and processing the target location information and at least part of the data stored in the memory to cause the information display to display the target's location on a plan view map representation of a hole comprising at least one feature such that the target's location relative to the at least one feature of the hole is graphically represented on the plan view map representation of the hole.

The golf device of the preceding paragraph can have any sub-combination of the following features: wherein the at least one feature in the plan view map representation of the hole comprises a boundary of a green of the hole, wherein the target comprises a pin of the hole, wherein the at least one processor is configured to cause the information display to display the location of the pin on the plan view map representation of the hole such that the pin's location relative to the boundary of the green is graphically represented on the plan view map representation and that distances between the pin's location and various points of the boundary of the green on the plan view map representation is generally proportionate to horizontal distances between the pin and various points of the boundary of the green; wherein determining the location of the golf device comprises obtaining device location information indicative of the golf device at the time of emission of laser beams to the target, wherein the device location information is in a format for use in displaying the location of the golf device on the plan view map representation; wherein the target location information indicative of the location of the target comprises at least one value for use in displaying the location of the target on the top plan view representation of hole, wherein determining the location of the golf device comprises computing at least one value for use in displaying the location of the golf device on the top plan view map representation of the hole; wherein the golf device further comprises a button for receiving a user's selection of the target, wherein the laser module is configured to emit laser beams when the button is pressed or touched; wherein the orientation of the golf device corresponds to a direction in which the golf device is aimed at the target to emit the laser beams to the target, wherein determining the orientation of the golf device comprises computing at least one angular value of the direction relative to a reference direction; wherein the at least one angular value comprises a horizontal angular value relative to the reference direction projected onto an imaginary horizontal plane that defines a plan view for the plan view map representation; wherein the at least one angular value comprises a vertical angular value relative to an imaginary horizontal plane that defines a plan view for the plan view map representation; wherein computing the target location information comprises determining at least one value representing the location of the target that is at the determined distance from the determined location of the golf device in a direction in which the device is aimed at the target in the determined orientation, wherein the at least one value represents the location of the target in a three-dimensional coordinate system; and wherein computing the target location information comprises determining at least one value representing the location of the target that is at the determined distance from the determined location of the golf device in a direction in which the device is aimed at the target in the determined orientation, wherein the at least one value represents the location of the target on an imaginary horizontal plane that defines a plan view of the plan view map representation.

In one aspect, a method of providing information on a golf device comprises: providing any golf device described herein; emitting laser beams from the laser module to a visible target on a golf course in response to user selection of the visible target; detecting reflections of at least part of the laser beams from the visible target; determining a distance between the golf device and the visible target based on the laser module's emission of laser beams and detection of their reflections; determining a location of the device based on GPS signals received at the GPS module of the device; determining an orientation of the device at the time of emission of laser beams to the visible target; computing target location information indicative of a location of the visible target using each of the determined location of the golf device, the determined distance between the golf device and the visible target, and the determined orientation of the golf device; processing the target location information and at least part of the data stored in the memory of the golf device to display the visible target's location on a plan view map representation of a hole comprising at least one feature; and displaying, on the information display, a plan view map representation of the hole such that the target's location relative to the at least one feature of the hole is graphically represented on the plan view map representation of the hole.

The method of the preceding paragraph can have any sub-combination of the following features: wherein the at least one feature in the plan view map representation of the hole comprises a boundary of a green of the hole, wherein the visible target comprises a pin of the hole, wherein the golf device displays the location of the pin on the plan view map representation of the hole such that the pin's location relative to the boundary of the green is graphically represented on the plan view map representation and that distances between the pin's location and various points of the boundary of the green on the plan view map representation is generally proportionate to horizontal distances between the pin and the various points of the boundary of the green; wherein determining the location of the golf device comprises obtaining device location information indicative of the golf device at the time of emission of laser beams to the target, wherein the device location information is in a format for use in displaying the location of the golf device on the plan view map representation; wherein the target location information indicative of the location of the visible target comprises at least one value for use in displaying the location of the target on the top plan view representation of hole, wherein determining the location of the golf device comprises computing at least one value for use in displaying the location of the golf device on the top plan view map representation of the hole; wherein the orientation of the golf device corresponds to a direction in which the golf device is aimed at the visible target to emit the laser beams to the visible target, wherein determining the orientation of the golf device comprises computing at least one angular value of the direction relative to a predetermined reference direction; wherein the at least one angular value comprises a horizontal angular value relative to the reference direction projected onto an imaginary horizontal plane that defines a plan view for the plan view map representation; wherein the at least one angular value comprises a vertical angular value relative to an imaginary horizontal perpendicular that defines a plan view for the plan view map representation; wherein computing the target location information comprises determining at least one value representing the location of the target that is at the determined distance from the determined location of the golf device in a direction in which the device is aimed at the target in the determined orientation, wherein the at least one value represents the location of the target in a three-dimensional coordinate system; and wherein computing the target location information comprises determining at least one value representing the location of the target that is at the determined distance from the determined location of the golf device in a direction in which the device is aimed at the target in the determined orientation, wherein the at least one value represents the location of the target on an imaginary horizontal plane that defines a plan view of the plan view map representation.

### BRIEF DESCRIPTION OF DRAWINGS

The foregoing and other features, aspects and advantages of the present invention are described in detail below with reference to the drawings of various embodiments, which are intended to illustrate and not to limit the invention. The drawings comprise the following figures in which:

FIG. 1 illustrates a perspective view of a golf device in accordance with an embodiment;

FIG. 2A illustrates an example use of a golf device in accordance with an embodiment;

FIGS. 2B and 2C illustrate views that the golf device of FIG. 2A may present to its user in accordance with an embodiment;

FIG. 2D illustrates the various parameters used to determine the target location in accordance with an embodiment;

FIG. 3 illustrates a laser emitting direction of a golf device in accordance with an embodiment;

FIG. 4 illustrates a block diagram of a golf device in accordance with an embodiment;

FIGS. 5 and 6 illustrate angles at which a user can hold a golf device in accordance with an embodiment;

FIGS. 7A-7C and 8 illustrate angles at which a user can hold a golf device in accordance with an embodiment;

FIGS. 9A and 9B illustrate a view through a scope and a display screen of a golf device in accordance with an embodiment;

FIGS. 10A and 10B illustrate a view through a scope and a display screen of a golf device in accordance with an embodiment;

FIGS. 11A and 11B illustrate a view through a scope and a display screen of a golf device in accordance with an embodiment;

FIGS. 12A and 12B illustrate a view through a scope and a display screen of a golf device in accordance with an embodiment;

FIG. 13 illustrates a flowchart depicting methods of displaying a hole cup location on a map in accordance with an embodiment; and

### DETAILED DESCRIPTION

Embodiments of the invention will now be described with reference to the accompanying figures. The terminology used in the description presented herein is not intended to be interpreted in any limited or restrictive manner, simply because it is being utilized in conjunction with a detailed description of certain specific embodiments of the invention. Furthermore, embodiments of the invention may comprise several novel features, no single one of which is solely responsible for its desirable attributes or which is essential to practicing the inventions herein described.

### Playing Golf

A game of golf typically involves playing 18 holes, and in each hole, the objective is to hit the golf ball into the hole cup located on the green in as few strokes as possible. Thus, being able to accurately estimate the distance to the hole cup is important, because the remaining distance to the hole cup determines which golf club should be used to strike the ball.

### Estimating Distance to Hole Cup

There are several ways a golfer might estimate the distance to the hole cup. One way to estimate the distance is by observing the hole cup location with the naked eye and guessing the distance between the golfer and the hole cup based on the observation. Another way might be to use a golf GPS device that provides distance information to predetermined locations on the golf course and to infer the distance from the golfer to the hole cup based on known distances to other objects on the golf course. Yet another way might be to use a laser rangefinder that provides the distance from the golfer to a designated target.

### Unaided Observation

An experienced golfer may have developed a good sense of distance over time and thus be able to estimate the distance to the hole cup with some accuracy. The hole cup location is typically marked by a flag that is placed in the hole cup, and if the golfer can see the flag, he or she may be able to approximate the location of the hole cup within the green. Further, the color of the flag may indicate whether the hole cup is near the front (e.g., a red flag) of the green, near the center of the green (e.g., a white flag), or near the back of the green (e.g., a blue flag). Thus, when the flag is visible to the golfer, he or she may be able to more accurately estimate the actual location of the hole cup using the observed location and color of the flag. In addition, each hole typically contains markers that indicate the distances to the green, and the golfer can use such markers to further improve the accuracy of his or her estimation. However, the estimation performed by the golfer still involves some guesswork on the golfer's part and is subject to human error.

### Golf GPS Device

A golf GPS device can provide how far the golfer is from various objects on the golf course, such as the green, the fairway, etc. For example, the golf GPS device may provide the distances to the front, center, and back of the green, and the golfer can estimate how far he or she has to hit the ball to get it on the green based on the distances provided by the golf device. However, the hole cup is not a fixed object, and its actual location is changed from time to time. Many golf courses change the hole cup locations daily, e.g., to add variety to the game or to spread out the damage to the grass due to the increased foot traffic near the hole cup. A difference of just a few yards can separate a great shot from a mediocre shot, especially on the green, and the golfer's ballpark estimate based on the distances to immobile objects on the course provided by the golf device may be insufficient.

Laser Rangefinder

A laser rangefinder provides the distance from the golfer to a target. The golfer may point the laser rangefinder at the flag located at the hole cup to determine the distance to the hole cup. However, the golfer cannot be sure that the laser rangefinder has accurately measured the distance to the flag or some other intervening object on the golf course. Further, the laser rangefinder typically will not provide any information other than the measured distance to its target. Thus, even if the golfer is able to determine the distance to the flag using the laser rangefinder, the golfer cannot know where the hole cup may be on the green or what other objects are situated near the hole cup. For example, a hole cup that is 100 yards away from the golfer but dangerously close to a bunker may require a different strategy than another hole cup that is 100 yards away from the golfer but in the middle of the green. Such a difference is often not apparent until the golfer is very close to the green.

### Mere Combination

A mere combination of the methods discussed above (e.g., unaided observation, golf GPS device, and a laser rangefinder) would still have limitations. Even knowing the accurate distance to the actual hole cup (e.g., provided by the laser rangefinder) and the distances to various immobile objects around the golf course, the golfer still has no way of knowing the location of the actual hole cup with respect to one or more objects near the green. For example, the golfer might want to know how far the hole cup is from the left edge of the green, which may be dangerously close to a bunker, or how far the hole cup is from the back edge of the green, which is near the boundary of the hole. The golfer may also know how far the hole cup is from each edge of the green to determine which club to use or to determine his or her swing strategy. Thus, simply combining some of these known methods for estimating the distance to the hole cup does not solve the problem of not knowing the location of the hole cup with respect to other hole features (e.g., bunker, hazard, tree, hole boundary, edges of the green, etc.).

### Desired Feature of Golf Device

Therefore, a golf device that can provide both the distance to the actual hole cup and the location information of the actual hole cup with respect to other hole features is desired, especially when the green and/or the flag marking the location of the hole cup are visible to the golfer.

### Improved Golf Device

According to aspects of the present disclosure, an improve golf device can provide the golfer with the distance from the golfer to the actual hole cup as well as the location of the actual hole cup with respect to other hole features. Thus, the improved golf device can provide a critical advantage to the golfer by allowing the golfer to formulate his or her play strategy based on a more complete set of information.

### Operation of Improved Golf Device

The improved golf device (hereinafter “golf device”) according to aspects of the present disclosure utilizes the GPS technology, the laser rangefinder technology, and other technologies to provide additional information to the golfer that would not otherwise be obtainable using the golf GPS device, the laser rangefinder, or a combination thereof. More specifically, according to various embodiments, the golf device measures the distance from the golfer to the hole cup (e.g., by targeting the flag indicating the hole cup location) using the laser rangefinder technology, determines the direction from the golfer to the hole cup (e.g., relative to a known direction such as the magnetic north) using an orientation determination technology (e.g., using a magnetometer and/or an accelerometer), and determines the actual location of the hole cup, and displays the actual location of the hole cup alongside other hole features via a display screen.

### Determining and Plotting the Actual Hole Cup Location

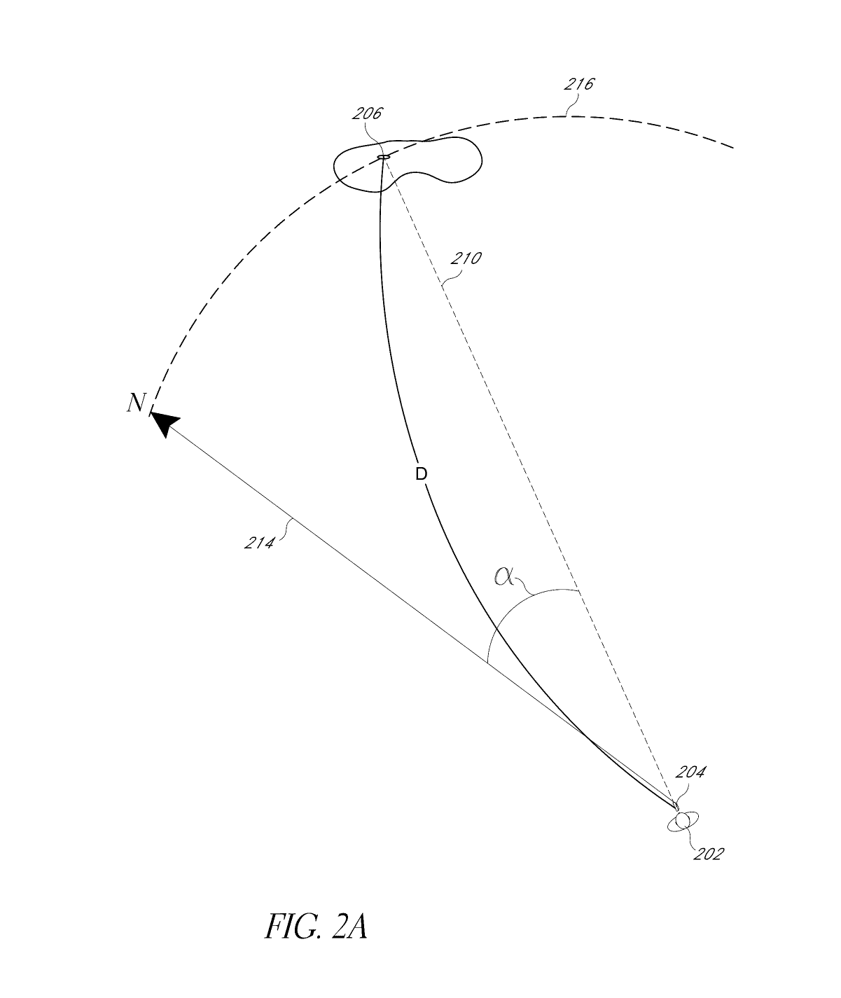

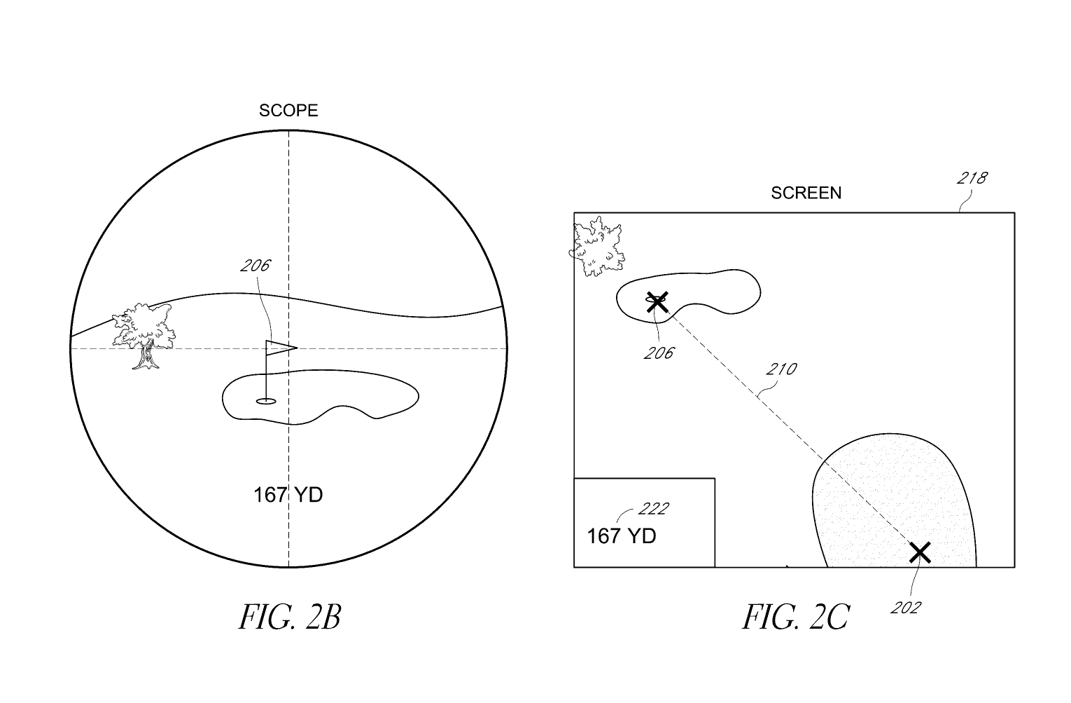

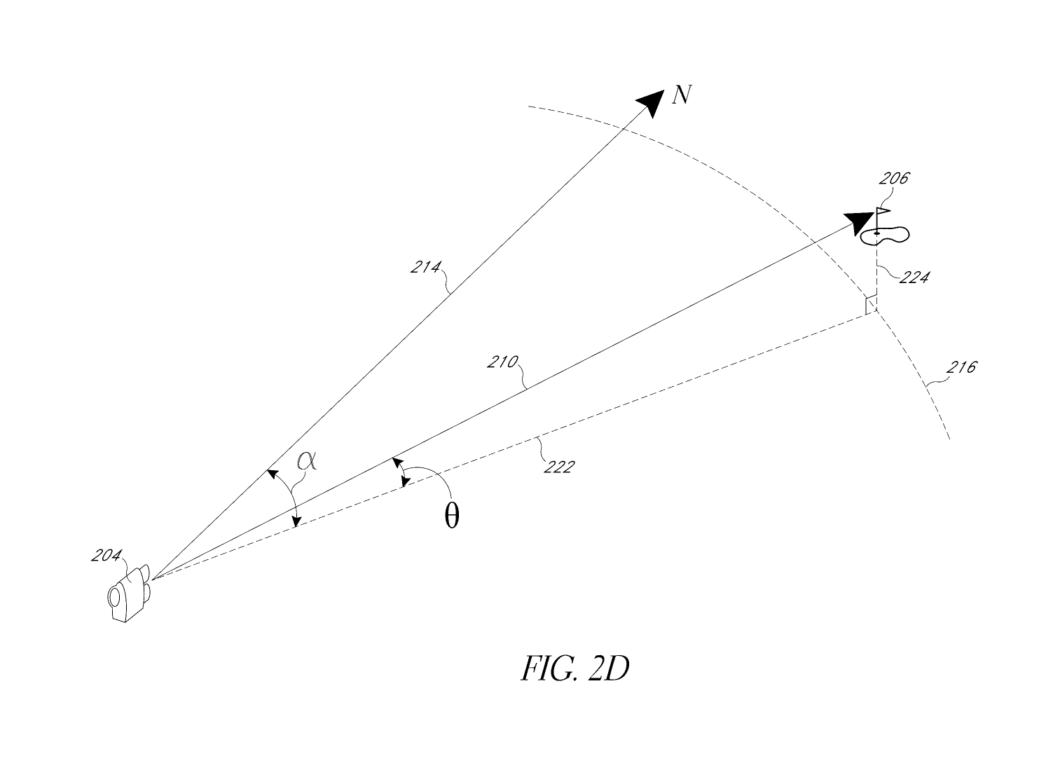

More specifically, according to various embodiments, (i) the distance from the golf device to the hole cup is determined using the laser rangefinder technology, (ii) the orientation (e.g., which may include an angle of incline/decline and an azimuth angle, as described in more detail below) of the golf device is determined using the orientation determination technology, and (iii) the current location of the golf device is determined using the GPS technology. The golf device may then determine the location of the hole cup based on (i) the distance, (ii) the orientation (e.g., direction), and (iii) the current location. For example, the golf device selects from a plurality of points that are equidistant from the current location by the determined distance (e.g., points on the curve 216 shown in FIG. 2A) using the determined orientation, and plots the target corresponding to the selected point on the map representation of the golf course displayed on the display screen of the golf device. In another example, the golf device determines the intersection of the curve 216 and the line from the golfer to the target, and plots the intersection on the map representation of the golf course. In yet another example, in the case that the location is represented in the two dimensional space (e.g., using x-y coordinates, using latitude and longitude, etc.), the golf device may calculate the displacement in each direction (e.g., by multiplying the cosine of the azimuth to the distance to calculate the x-direction displacement, and by multiplying the sine of the azimuth to the distance to calculate the y-direction displacement) and add the displacements to the coordinates of the current location to determine the coordinates of the hole cup. After the location of the hole cup has been determined, the golf device can plot the location of the hole cup on a map, illustrating where the hole cup is situated with respect to other hole features, so that the golfer can better formulate his or her play strategy in view of the hole cup location and its surrounding hole features.

### Perspective View of Improved Golf Device

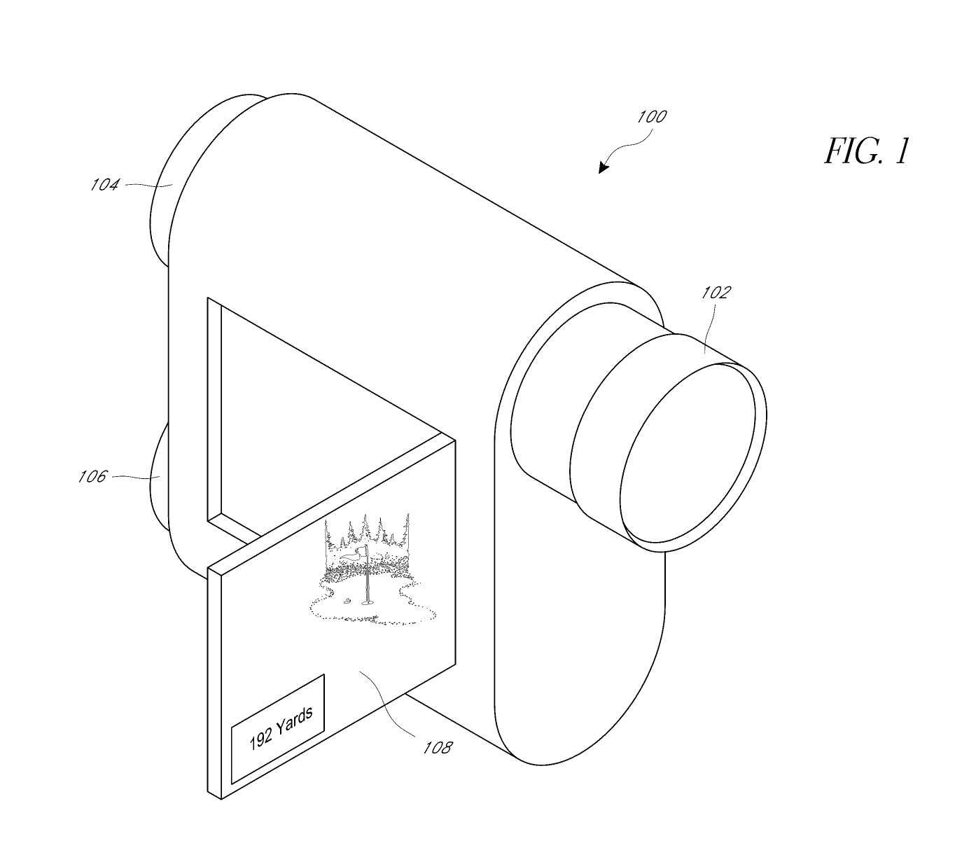

FIG. 1 illustrates a perspective view of the golf device in accordance with an example embodiment. As shown in FIG. 1, the golf device 100 includes an eyepiece 102 through which the user may view objects on the golf course, a laser emission aperture 104 for emitting laser beams, a laser detector aperture 106 for receiving reflected laser beams, a display screen 108 for conveying visual information to the user. Although not shown in FIG. 1, the golf device 100 may include one or more buttons or sensors for receiving the user's input.

The eyepiece 102 may be used by the user of the golf device 100 to view various objects on the golf course. In one embodiment, one or more lenses disposed inside the golf device 100 cause magnified images of the various objects to be seen through the eyepiece 102. In another embodiment, the images of the various objects are displayed without any magnification.

In one embodiment, the device 100 performs one or more functionalities of a laser rangefinder. For example, although not shown in FIG. 1, a laser emitter (e.g., a laser diode) may be disposed in the device 100 to emit laser beams toward a target through the laser emission aperture 104. Also, although not shown in FIG. 1, a laser detector (e.g., a photodiode) may be disposed in the device 100 to detect the laser beams reflected off the target and received through the laser detector aperture 106. The functionalities of a laser rangefinder, such as measuring the distance to a target, may be implemented in the device 100 using any techniques currently known or developed in the future, and the details thereof are omitted for brevity.

### Example Use of Improved Golf Device

With reference to FIGS. 2A-2C, an example use of the golf device is described. FIG. 2A shows a golfer 202 using a golf device 204. In FIG. 2A, the golfer 202 is pointing the golf device 204 at a flag 206 indicating the location of the hole cup. FIG. 2B shows the view through the eyepiece of the golf device 204. In the example of FIGS. 2A-2C, the golfer has the crosshair pointed at the flag 206 located at the hole cup, and the golf device 204, using the laser rangefinder technology, for example, determines the distance D (shown in FIG. 2A) between the golf device 204 and the flag 206 and displays the distance through the scope of the golf device 204. The direction 210 in which the golfer points the golf device 204 to the flag 206 makes an angle α with a reference direction 214. The reference direction 214 is used for defining the orientation of the golf device 204. In one embodiment, the reference direction 214 is the magnetic north. In such an embodiment, the angle α indicates the direction in which the golf device 204 is pointed with respect to the magnetic north. However, the reference direction 214 is not limited as such and may be any line that may be used as a reference for defining the orientation of the golf device 204. In one embodiment, the angle α is used to plot the location of the flag 206 on a displayed map of the golf course. In some embodiments, the golf device 204 may first determine the location of the flag 206 and plot the location of the flag 206 on a corresponding location on the displayed map of the golf course. In one example, the golf device 204 determines the GPS coordinates of the flag 206 based on the distance D, the angle α, and the GPS coordinates of the current location of the golf device 204, as described below, and plots the determined GPS coordinates of the flag 206 on the displayed map of the golf course. In other embodiments, the golf device 204 plots an intersection of the direction 210 and a curve 216 (shown in FIG. 2A) that includes a plurality of points that are equidistant from the golf device 204 (e.g., by the distance D determined using the laser rangefinder technology) on the displayed map of the golf course.

### Horizontal and Vertical Components of Direction and Distance

It should be noted that FIG. 2A is a two-dimensional (2-D) representation of a golfer using the golf device 204 on a golf course, and the direction 210 in which the golf device 204 is pointed at the flag 206 may have a vertical component (e.g., out of the page or into the page in the example of FIG. 2A) as well as a horizontal component (e.g., parallel to the page in the example of FIG. 2A). For example, the horizontal component of the direction 210 may be parallel to the surface of the earth. Thus, the angle α may be the angle that the horizontal component of the direction 210 makes with the reference direction 214. Similarly, the distance D from the golf device 204 and the flag 206 may be a horizontal component of the actual distance from the golf device 204 and the flag 206. For example, the golf device 204 and the flag 206 may be situated at different altitudes, and the relevant distance for plotting the location of the flag 206 on a 2-D map of the golf course displayed on the display screen (e.g., display screen 108 of FIG. 1) may be the horizontal component of the actual distance calculated by a laser module of the golf device 204 (e.g., using the laser rangefinder technology). The horizontal component (e.g., distance D of FIG. 2A) may be determined by multiplying the distance calculated by the laser module by the cosine of the angle of incline or decline (not shown in FIG. 2A) that the direction 210 forms with respect to the surface of the earth. In some embodiments, the angle of incline or decline may be ignored and the distance calculated by the laser module may be used as the distance D for plotting the location of the flag 206.

### Plotting Target on 2-D Map Representation

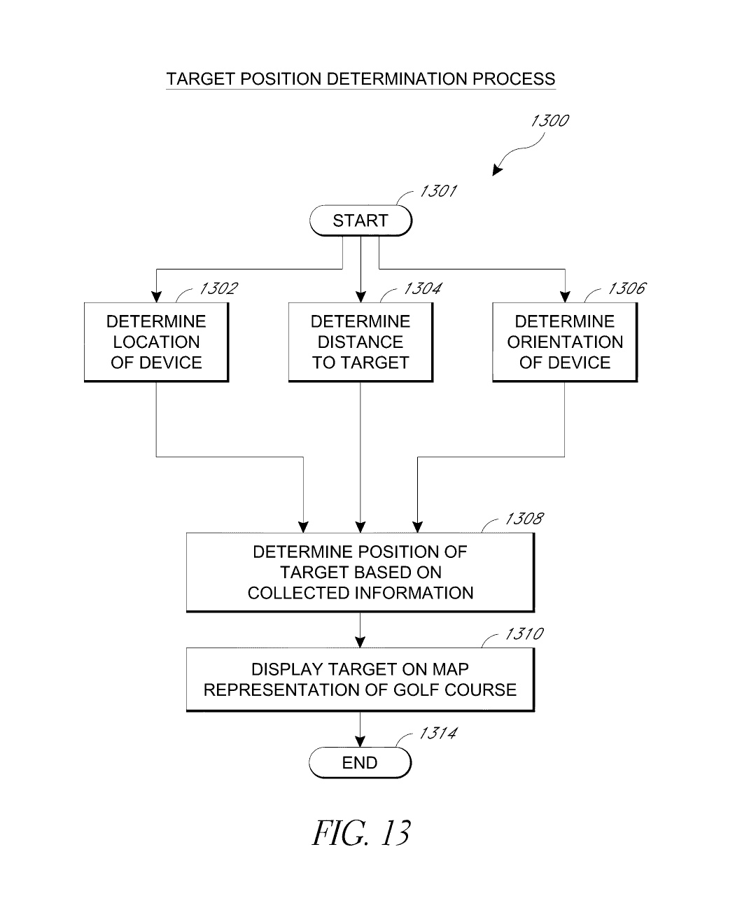

After the golf device 204 determines the distance D and the angle α, the golf device 204 may plot the location of the flag 206 on a 2-D map representation of the golf course that is displayed on the display screen of the golf device 204. The golf device 204 may identify a single point from a plurality of points that are equidistant (e.g., by the distance D) from the location of the golf device 204 by using the angle α. Alternatively, the golf device 204 may calculate the GPS coordinates of the location of the flag 206 using the GPS coordinates of the current location of the golf device 204, the distance D, and the angle α. The techniques for plotting the location of the flag 206 or other targets are described in greater detail below with reference to FIG. 13. Although the present application describes one or more embodiments using a 2-D map representation, a 3-D map representation may also be used instead. Such a 3-D map representation displayed on the display screen of the golf device 204 may include indications of the elevation.

### Plotting Hole Cup Location on Displayed Map

The golf device may display the map of the golf course on its display (e.g., display screen 108 of FIG. 1). FIG. 2C illustrates an example display screen 218 that illustrates the golfer 202, the flag 206, and the direction 210 in which the golf device 204 is pointed at the flag 206. By knowing where the hole cup is located with respect to other hole features, the golfer can better formulate his or her play strategy in view of the hole cup location and its surrounding hole features.

### 3-D Illustration of Distances and Angles

FIG. 2D illustrates the various parameters used to determine the target location in accordance with an embodiment. In FIG. 2D, the golf device 204 is point to the flag 206, indicated by the direction 210 from the golf device 204 to the flag 206. The direction 210 has a horizontal component 222 that is parallel to the reference plane (e.g., surface of the earth) and a vertical component 224 that is perpendicular to the reference plane. The curve 216 includes a plurality of points on the reference plane that are equidistant (e.g., by the length of the horizontal component 222) from the golf device 204. The angle that the direction 210 makes with the reference plane is illustrated in FIG. 2D as angle θ. The angle that the horizontal component 222 makes with the reference direction 214 (e.g., the true north or the magnetic north) is illustrated as angle α. In the example of FIG. 2D, the length of the horizontal component 222 is equal to the length of the direction 210 (e.g., measured by the laser module) multiplied by the cosine of the angle θ. Similarly, the length of the vertical component 222 (e.g., the difference in elevation between the golf device 204 and the flag 206) is equal to the length of the direction 210 multiplied by the sine of the angle θ.

### 2-D Mode Vs. 3-D Mode

The golf device may determine and plot the target location on the display screen in a two-dimensional (2-D) mode (e.g., FIG. 2A) or in a three-dimensional (3-D) mode (e.g., FIG. 2D). In the 2-D mode, the golf device ignores parameters in the direction perpendicular to the surface of the earth (e.g., z-direction). For example, the golf device does not take tilts, angles of incline/decline, or elevation into account when determining and plotting the target location on the display screen. In one example, the golf device uses the distance represented by the direction 210 of FIG. 2D as the distance between the golf device 204 and the flag 206 on a 2-D reference plane (e.g., the surface of the earth). On the other hand, in the 3-D mode, the 3-D parameters (e.g., tilts, angles of incline/decline, or elevation) are used to determine and plot the target location on the display screen. For example, the golf device determines the distance represented by the horizontal component 222 using the angle θ of FIG. 2D, and uses the determined distance as the distance between the golf device 204 and the flag 206 on a 2-D reference plane (e.g., the surface of the earth).

### Mode Selection Based on Map Representation

In one embodiment, the golf device plots the target location in the 2-D mode if the map representation displayed on the display screen is 2-D. Similarly, the golf device plots the target location in the 3-D mode if the map representation displayed on the display screen is 3-D.

### Mode Selection Based on Angle of Incline/Decline

In one embodiment, if the angle of incline (or tilt) is less than a threshold angle, the golf device determines and plots the target location in the 2-D mode, and if the angle of incline is greater than or equal to the threshold angle, the golf device determines and plots the target location in the 3-D mode. For example, if the angle of incline is less than 5°, the golf device determines and plots the target location in the 2-D mode (e.g., without taking the angle of incline into consideration). Similarly, if the angle of incline is greater than or equal to 5°, the golf device determines and plots the target location in the 3-D mode (e.g., while adjusting the target distance based on the angle of incline).

### Predetermined Mode Selection

In one embodiment, 3-D parameters are not considered. In other words, the golf device always determines and plots the target location in the 2-D mode. In such an embodiment, the distance measured by the laser rangefinder technology is not adjusted based on the angle of incline/decline before the distance is used to determine and plot the target location on the map representation. This embodiment effectively ignores elevation. In another embodiment, 3-D parameters are considered if available. In other words, the golf device always determines and plots the target location in the 3-D mode if 3-D parameters are available (e.g., angle of incline/decline, elevation, etc.). In such an embodiment, the distance measured by the laser rangefinder technology is adjusted based on the elevation or the angle of incline/decline before the distance is used to determine and plot the target location on the map representation.

### Comparison of the Two Modes

In one embodiment, the golf device determines the target position on the map representation in both the 2-D mode and the 3-D mode, and if the determined target positions differ by a threshold amount, the 3-D mode is selected. If the difference is less than the threshold amount, the 2-D mode is selected. In one embodiment, both the actual distance (e.g., measured by the laser rangefinder module) to the target and an adjusted distance (e.g., based on the angle of incline/decline) to the target are displayed to the user of the golf device 204. The adjusted distance may be the actual distance viewed from the top (e.g., 2-D distance) or a distance that the golfer should aim for in view of the incline/decline (which should be greater than the actual 2-D distance if there is an angle of incline, and smaller than the actual 2-D distance if there is an angle of decline).

### Target Direction of Improved Golf Device

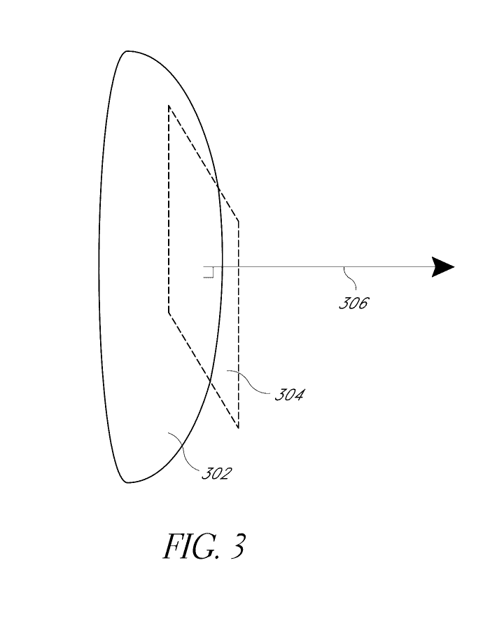

As illustrated in FIG. 2A, the golf device 204 may be pointed at the flag 206, such that the direction 210 in which the golf device 204 is pointed at the flag 206 forms the angle α with the reference direction 214. FIG. 3 illustrates an example method for defining the direction 210. In the example of FIG. 3, a lens 302, an imaginary plane 304, and a laser beam emission direction 306 are shown. The lens 302 may be an objective lens through which the device emits laser beams. The imaginary plane 304 is a tangent plane that is in contact with the lens 302 at the center point of the lens 302. The laser beam emission direction 306 passes through the center point of the lens 302 and is perpendicular to the imaginary plane 304. The laser beam emission direction 306 may be equivalent to the direction 210 illustrated in FIG. 2A. For example, the golf device 204 may determine the orientation of the golf device 204 by determining the angle α between the direction 210 (e.g., laser beam emission direction 306) and the reference direction 214 (e.g., magnetic north). In another embodiment, the golf device 204 uses the direction in which the laser beams are actually emitted towards the target, which may be different from the laser beam emission direction 306. Although the laser beam emission direction 306 is illustrated as shown in the example of FIG. 3, other methods of determining the laser beam emission direction may be used. In one embodiment, an actual emission direction of the laser beams is used for determining the orientation of the golf device 204. In another embodiment, another direction that is different from the actual emission direction of the laser beam is used for determining the orientation of the golf device 204.

### Example Configuration of Improved Golf Device

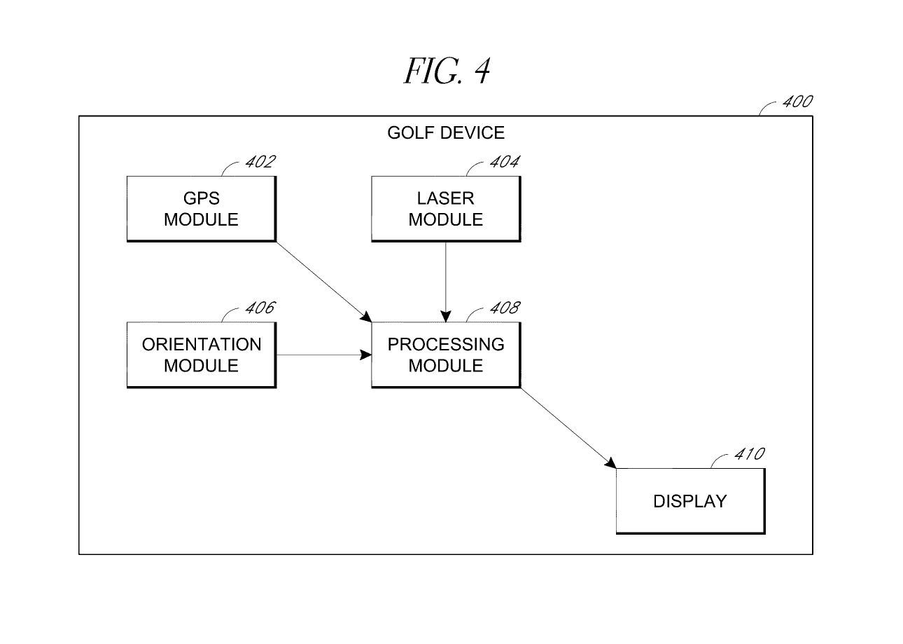

FIG. 4 illustrates a block diagram of a golf device, according to an example embodiment. As shown in FIG. 4, golf device 400 may include a GPS module 402, a laser module 404, an orientation module 406, a processing module 408, and a display 410. The processor 402 may comprise one or more processors.

### Communication Between Components

In the example of FIG. 4, the arrows may indicate the flow of information. For example, the GPS module 402 determines the location of the golf device 400 and provides the location information along with relevant map data to the processing module 408. The laser module 404 determines the distance from the golf device 400 to the target, and provides the distance information to the processing module 408. The orientation module 406 determines the orientation of the golf device 400 (e.g., the direction in which the golf device 400 is facing, with respect to a reference direction) and provides the orientation information to the processing module 408. The information provided to the processing module 408 may be raw data collected by the respective components (e.g., GPS module 402, laser module 404, and orientation module 406) or data processed by the respective components (e.g., the location of the golf device 400, the distance to the target, and the orientation of the golf device 400, respectively). The processing module 408 uses the information provided by the respective components to determine the actual location of the hole cup and causes the actual hole cup location, along with other features of the hole, to be displayed on the map of the golf course displayed via the display 410. Although the arrows originating from the GPS module 402, the laser module 404, and the orientation module 406 each point to the processing module 408 in the example of FIG. 4, in another embodiment, one or more of the arrows may be bi-directional, indicating that information flows in both directions. For example, each of the GPS module 402, the laser module 404, and the orientation module 406 may exchange raw data and processed data (e.g., with each other and/or with the processing module 408) to make certain calculations and determinations. The GPS module 402, laser module 404, and orientation module 406 are described in greater detail below.

### GPS Module

The GPS module 402 receives signals from satellites and/or other signals such as correction signals, and calculates the positional coordinates of the GPS module 402 (or the golf device 400). The golf device 400 may utilize this positional data to calculate (e.g., via the GPS module 402 and/or the processor 408) and display distances from the golf device 400 to various features on the golf course. For example, GPS coordinates of various features on the golf course may be stored in a memory included in the golf device 400.

### Data Processing by GPS Module

In one embodiment, the GPS module 402 provides the processing module 408 with the GPS coordinates (or some other form of location indicator) indicating the current location of the golf device 400. For example, the GPS module 402 may include one or more processors used for calculating the GPS coordinates using the received signals. Alternatively, the GPS module 402 may use the processing power of the processing module 408 to perform any calculations to determine the GPS coordinates of the golf device 400. In another embodiment, the GPS module 402 provides the raw data collected from satellites (or other sources) to the processing module 408, and the processing module 408 processes the raw data to determine the GPS coordinates (or some other form of location indicator) of the golf device 400.

### Laser Module

The laser module 404 uses a laser beam to determine the distance from the golf device 400 to a target object on the golf course. The laser module 404 may include a laser source for emitting a laser beam towards a target, a laser detector for receiving the laser beam reflected off the target, and one or more components for measuring the angle at which the laser beam is emitted or received and/or for measuring the time that the laser beam took to be reflected off the target and returned to the golf device. For example, the laser source may be a laser diode, and the laser detector may be a photodiode. The laser module 404 may include one or more processors for processing the data collected by one or more components of the laser module 404.

### Example Methods for Measuring Distance

In one embodiment, the laser module 404 sends a laser beam towards the target and measures the time taken by the laser beam to be reflected off the target and returned to the golf device 400. In another embodiment, the laser module 404 uses the triangulation method to determine the distance from the golf device 400 to the target object. The laser rangefinder functionalities of the laser module 404 may be implemented with any techniques currently known or developed in the future, and the details thereof are omitted for brevity.

### Data Processing by Laser Module

In one embodiment, the laser module 404 determines the distance to the target and provides the determined distance to the processing module 408. In another embodiment, the laser module 404 collects certain data that may be used to determine the distance to the target (e.g., elapsed time between the emission of the laser beam and the detection of the reflected laser beam, the angle at which the reflected laser beam was received, etc.) and provides the collected data to the processing module 408. The processing module 408 uses the data provided by the laser module 404 to determine the distance to the target. In some embodiments, the data collected by the laser module 404 undergoes an initial processing by the laser module 404 before being sent to the processing module 408.

### Orientation Module

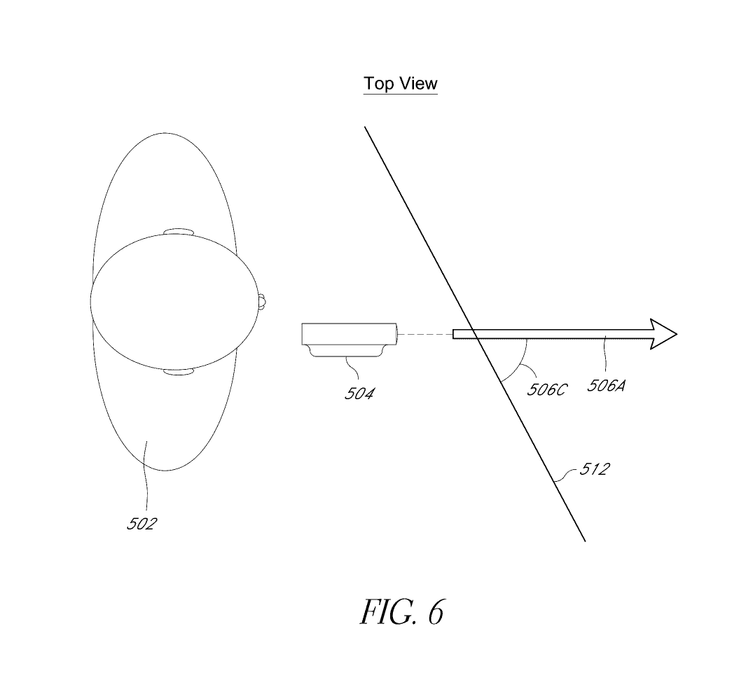

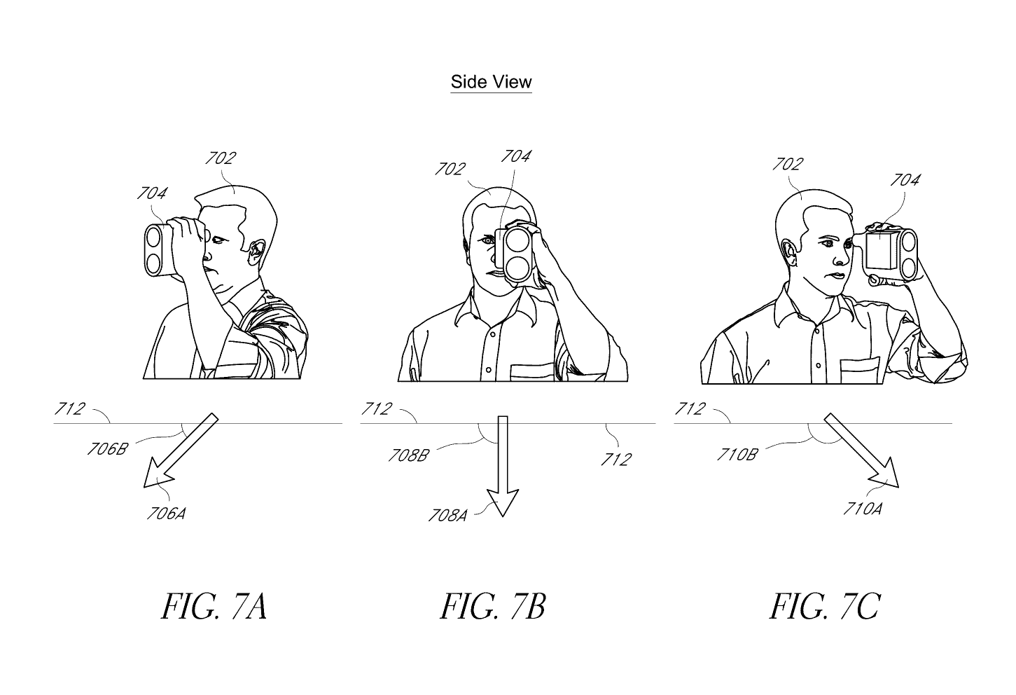

The orientation module 406 determines the orientation (e.g., the direction in which the golf device 400 is facing, with respect to a reference direction) of the golf device 400. The orientation module 406 may determine the orientation of the golf device 400 by determining one or more angles relative to one or more reference frames. For example, the orientation module 406 may determine the angle of incline (e.g., from the plane parallel to the surface of the earth, such as angle 506D shown in FIG. 5) and/or the azimuth angle (e.g., on the plane parallel to the surface of the earth, such as angles 706B, 708B, and 710B shown in FIG. 7). For example, the azimuth angle may indicate the angle that the laser emission direction of the golf device 400 makes with a reference direction (e.g., the magnetic north), measured clockwise, on the plane that is parallel to the surface of the earth. The angle of incline may indicate the acute angle that the laser emission direction of the golf device 400 makes with the plane that is parallel to the surface of the earth. In one embodiment, the reference plane with respect to which the angle of incline/decline is measured is a plane that is perpendicular to the direction in which the Earth's gravitational force is applied

### Example Methods for Determining Orientation

In one embodiment, the angles are measured by the orientation module 406. In another embodiment, the angles are determined based on one or more measurements such as magnetometer readings and/or accelerometer readings. For example, the azimuth angle may be determined by calculating the angle that the golf device 400 makes with the magnetic north based on the magnetometer readings, and the angle of incline may be determined by calculating the angle of tilt based on the accelerometer readings. One or more functionalities of magnetometers, accelerometers, gyroscopes, digital compasses, and/or other motion sensing devices may be implemented with any techniques currently known or developed in the future, and the details thereof are omitted for brevity.

### Data Processing by Orientation Module

In one embodiment, the orientation module 406 determines the orientation of the golf device 400 (e.g., the orientation of the golf device 400 at the time data is collected by the laser module 404), and provides the determined orientation to the processing module 408. For example, the determined orientation may comprise one or more angles that describe how the golf device 400 is/was oriented at the time the data is collected by the laser module 404. The orientation may also comprise a reference direction or a reference angle against which the orientation of the golf device is described. In another embodiment, the orientation module 406 collects certain data that may be used to determine the orientation of the golf device 400 (e.g., magnetometer reading, accelerometer reading, compass reading, etc.) and provides the collected data to the processing module 408. The processing module 408 uses the data provided by the orientation module 406 to determine the orientation (e.g., with respect to a reference direction) of the golf device 400. In some embodiments, the data collected by the orientation module 406 undergoes an initial processing by the orientation module 406 before being sent to the processing module 408.

### Processing Module

The processing module 408 determines the position of a target specified by the user based at least in part on the information received from the GPS module 402, the laser module 404, and/or the orientation module 406. In one embodiment, the processing module 408 determines the current position of the golf device 400 based on the positional information received from the GPS module 402, determines the distance to the target based on the distance information received from the laser module 404, and determines the orientation of the golf device 400 based on the orientation information received from the orientation module 406. Based on the received information, the processing module 408 determines the location of the target and plots the target on a map of at least a portion of the golf course.

Communication with Other Components

The processing module 408 communicates with a number of other components in the golf device 400, including the GPS module 402, the laser module 404, the orientation module 406, and the display 410. Although not shown in FIG. 4, the processing module 408 may further communicate with a local or external memory and/or other input and output devices such as a speaker and mechanical or digital buttons for inputting user commands. For example, the processing module 408 may execute program software that is stored on a local memory of the golf device 400 to perform one or more techniques described herein.

### Display

The display 410 may include one or more display screens that display, e.g., under the control of the processing module 408, the information processed by the processing module 408. The information may include an iconic representation of the hole cup location on a map of at least a portion of the golf course. For example, the display 410 may be provided on a side surface of the golf device 100 as shown in FIG. 1.

### Types of Display

The one or more display screens can be any of various conventional displays such as a liquid crystal display (LCD), a light-emitting diode (LED) display, etc., or any other display means to be developed in the future. In certain embodiments, the display 410 is a color display. In other embodiments, the display 410 is not a color display but is grayscale. The display 410 may be equipped with a touch sensitive display. The display 410 may provide the user with a user interface for communicating with the golf device 400.

### Displayed Content

In some embodiments, the display 410 displays details of a golf course where the golf device 400 is currently located. Such details can include the distance from the golf device 400 to various features in a particular hole. Such features can include the front of the green, back of the green, center of the green, front of a hazard, back of a hazard, front of the fairway, back of the fairway, the hole cup, and any other notable locations in the particular hole (or in other holes of the golf course).

### Map Data

The golf device 400 may include a memory that includes map data of numerous golf courses (e.g., including location of various holes and features in the holes). The map data may include map representations of the numerous golf courses, the map representations including various features of each golf course. When the user of the golf device 400 goes to a given golf course, the golf device 400 may select an appropriate map representation corresponding to the given golf course and cause the map representation to be displayed via the display 410. The golf device 400 may further display positional information (e.g., distances from the current location of the golf device 400 to various features illustrated in the map representation) on top of the displayed map representation of the golf course.

### Other Components of Improved Golf Device

The golf device 400 may include components other than those that are shown in FIG. 4. For example, the memory of the golf device 400 may include software that may configure the processing module 408 to run a golf application. Further the golf device 400 may include one or more inputs (e.g., physical or digital buttons) that allow the user of the golf device 400 to enter various user commands.

### Determining Orientation of Golf Device: Example #1

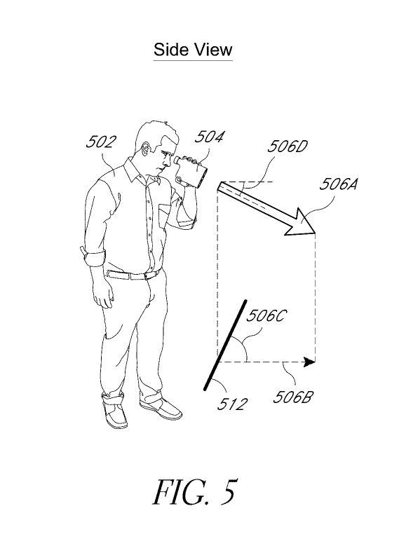

Turning to FIGS. 5 and 6, an example method of determining the orientation of the golf device is illustrated. FIG. 5 shows a side view of a golfer 502 who is aiming the golf device 504 at an angle of decline. The golfer 502 shown in FIG. 5 is holding the golf device 504 at a direction 506A (e.g., the direction 210 of FIG. 2A), and the horizontal component (e.g., the component that is parallel to the surface of the earth) of the direction 506A makes an angle 506C (e.g., the angle α of FIG. 2A) with the reference line 512 (e.g., the reference line 214 of FIG. 2A). The direction 506A at which the golfer 502 is holding the golf device 504 forms an angle 506D with the plane that is parallel to the surface of the earth. As discussed herein, the angle 506D may be used to adjust the distance calculated by the laser module of the golf device to determine the horizontal component (e.g., the distance D of FIG. 2A) of the distance from the golf device 504 to the target (e.g., the flag). As shown in FIG. 6, when viewed from the sky down at the golfer 502, the direction 506A makes the angle 506C with respect to the reference line 512.

### Determining Orientation of Golf Device: Example #2

Turning to FIGS. 7A-7C and 8, another example method of determining the orientation of the golf device is illustrated. FIG. 7A-7C each shows a front view of a golfer 702 who is aiming the golf device 704 at various radial directions (e.g., azimuth angles). The golfer 702 shown in FIG. 7A is holding the golf device 704 at a direction 706A (e.g., the direction 210 of FIG. 2A), which makes an angle 706B (e.g., the angle α of FIG. 2A) with the reference line 712 (e.g., the reference line 214 of FIG. 2A). The golfer 702 shown in FIG. 7B is holding the golf device 704 at a direction 708A (e.g., the direction 210 of FIG. 2A), which makes an angle 708B (e.g., the angle α of FIG. 2A) with the reference line 712 (e.g., the reference line 214 of FIG. 2A). The golfer 702 shown in FIG. 7C is holding the golf device 704 at a direction 710A (e.g., the direction 210 of FIG. 2A), which makes an angle 710B (e.g., the angle α of FIG. 2A) with the reference line 712 (e.g., the reference line 214 of FIG. 2A). As shown in FIG. 8, when viewed from the sky down at the golfer 702, the directions 706A, 708A, and 710A each crosses the reference line 712 at a different angle (e.g., angles 706B, 708B, and 710B, respectively).

### Adjustment #1 Based on Angle of Incline/Decline

In some embodiments, the processing module 408 may make adjustments to the distance information provided by the laser module 404 based on the angle of incline provided by the orientation module 406. For example, if the information provided by the orientation module 406 indicates that the golf device 400 was angled upward or downward at the time the laser module 404 collected data for measuring the distance, the processing module 408 may determine that the bird-eye view distance from the golf device 400 to the target to be displayed on the map is actually a fraction of the distance measured by the laser module 404. For example, if the golf device 400 was angled up 60 degrees at the time of distance measuring, the distance between the golf device 400 and the target on a plane that is parallel to the ground may be one half of the distance determined by the laser module 404 (since cosine of 60° is ½). Thus, in such a case, if the distance determined by the laser module 404 is 150 yards, on the map displayed on the golf device 400, the target would be shown as being 75 yards away from the user's location. In one embodiment, the angle of incline is monitored and/or measured using an accelerometer (not shown) disposed in the golf device 400. In some implementations, this adjustment is used for plotting a target location on the map.

### Adjustment #2 Based on Angle of Incline/Decline

In another embodiment, the processing module 408 may make adjustments to the distance information provided by the laser module 404 based on the angle of incline provided by the orientation module 406. For example, if the information provided by the orientation module 406 indicates that the golf device 400 was angled upward or downward at the time the laser module 404 collected data for measuring the distance, the processing module 408 may determine that the distance that the golfer should aim to hit the ball, on a plane that is parallel to the ground, may be longer or shorter than the distance determined by the laser module 404. For example, if the target is measured by the laser module 404 to be 200 yards away, but the orientation module 406 determines that the golf device 400 was angled at the time the distance is measured, the golfer should try to hit the ball a little farther than 200 yards due to the incline between the golfer and the target (e.g., if the golfer hit the ball such that it would travel 200 yards on the plane parallel to the ground, the ball would be stopped short by the incline). Similarly, if the target is measured by the laser module 404 to be 200 yards away, but the orientation module 406 determines that the golf device 400 was angled downward at the time the distance is measured, the golfer should try to hit the ball a little shorter than 200 yards due to the decline between the golfer and the target (e.g., if the golfer hit the ball such that it would travel 200 yards on the plane parallel to the ground, the ball would be travel beyond the 200 yard mark due to the decline). In one embodiment, the angle of incline is monitored and/or measured using an accelerometer (not shown) disposed in the golf device 400. In some implementations, this adjustment is used for displaying the distance information.

### Example Golf Device #1: Description

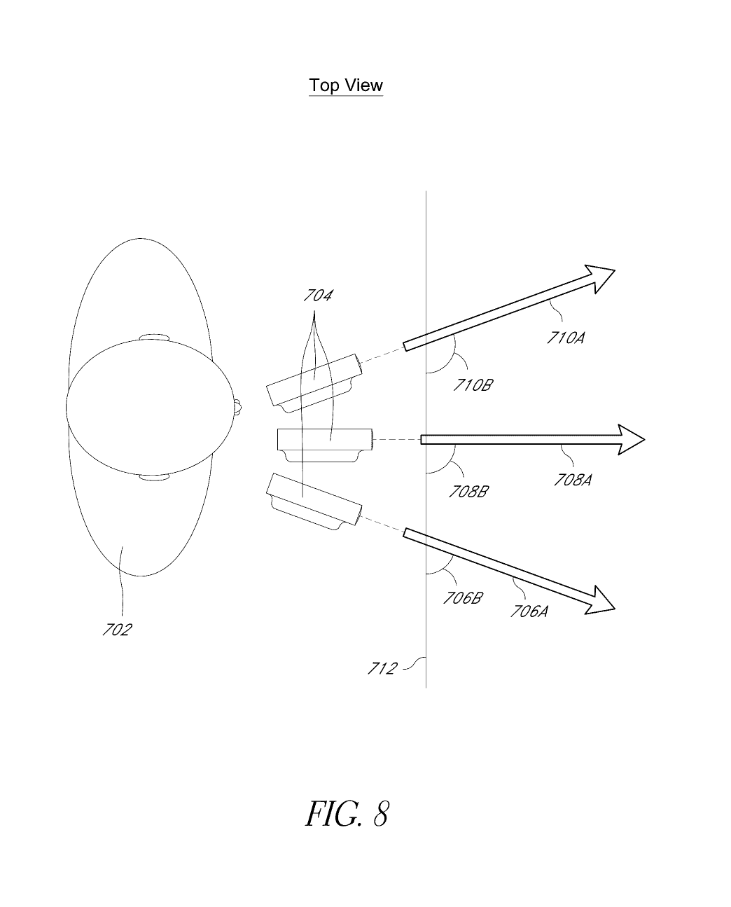

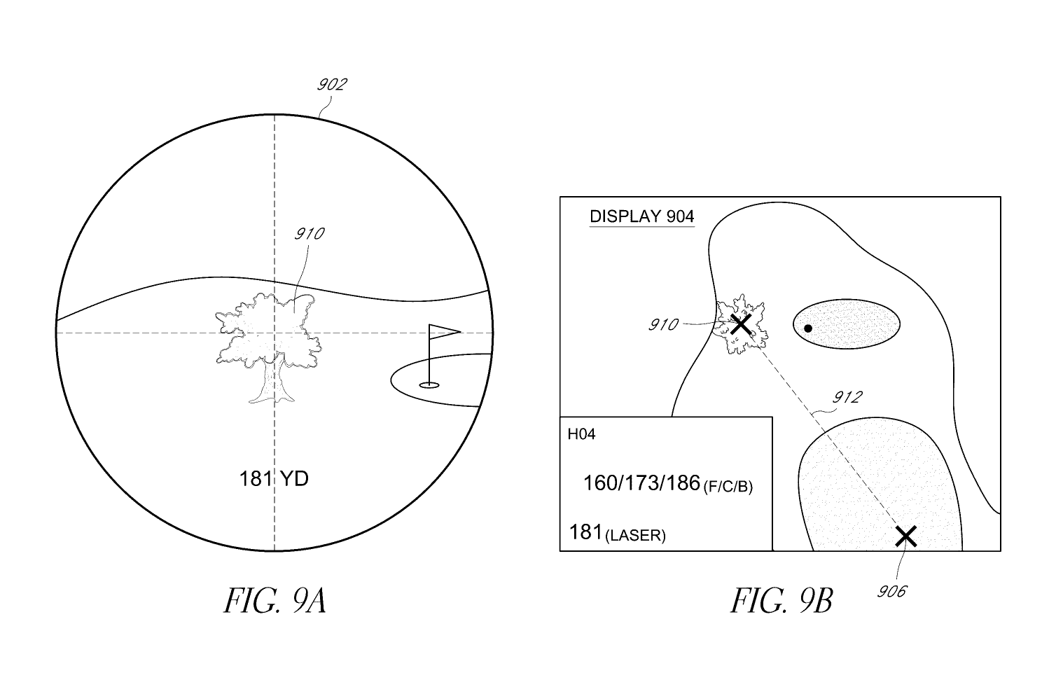

Turning to FIGS. 9A and 9B, an example method of displaying distance information is illustrated. FIG. 9A shows a scope 902 of an example golf device, and FIG. 9B shows a display 904 of the example golf device. As shown in FIG. 9A, the user has targeted a tree 910 near the green of the hole, and the distance from the user to the tree 910 is accordingly displayed at the bottom of the scope 902 (e.g., 181 YD). The display 904 shows the relative locations of the user and the tree targeted by the user (e.g., user location 906 and tree location 910, respectively). The location of the flag 910 may be calculated using any of the techniques described herein (e.g., using the distance determined by the laser module, the direction determined by the orientation module, and the location of the golf device determined by the GPS module). The display 904 also shows the direction 912 in which the golf device is pointed at the tree 910. The display 904 also indicates the distances to the front, center, and back of the green, along with the distance to the tree targeted by the user.

### Example Golf Device #1: Advantage

In the example of FIGS. 9A and 9B, the user can see where and how far away from the user the various objects on the golf course are located. Sometimes, it may be helpful to know the location of, and the distance to, a visible feature about which the golf device may not have any pre-configured information (e.g., known GPS coordinates in the map data stored in the memory). In this example, the user may want to make sure that he or she does not hit the ball beyond this tree. Knowing the distance to the tree (or any other object on the golf course) and the location thereof with respect to other features on the golf course, the user may be able to further fine-tune his or her strategy.

### Example Golf Device #2: Description

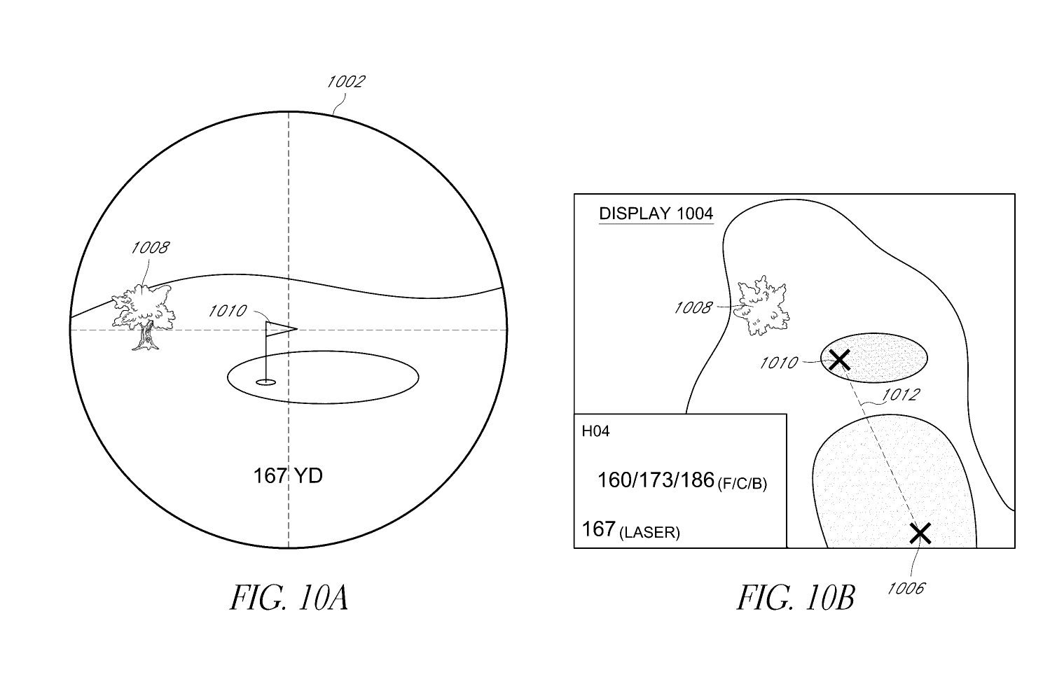

Turning to FIGS. 10A and 10B, an example method of displaying distance information is illustrated. FIG. 10A shows a scope 1002 of an example golf device, and FIG. 10B shows a display 1004 of the example golf device. As shown in FIG. 10A, the user has targeted the flag 1010 placed in the hole cup, and the distance from the user to the flag is accordingly displayed at the bottom of the scope 1002 (e.g., 167 YD). The display 1004 shows the relative locations of the user and the flag targeted by the user (e.g., user location 1006 and flag location 1010, respectively). The location of the flag 1010 may be calculated using any of the techniques described herein (e.g., using the distance determined by the laser module, the direction determined by the orientation module, and the location of the golf device determined by the GPS module). The display 1004 also shows the tree 1008 and the direction 1012 in which the golf device is pointed at the flag 1010. The display 1004 also indicates the distances to the front, center, and back of the green, along with the distance to the flag targeted by the user.

### Example Golf Device #2: Advantage

In the example of FIGS. 10A and 10B, the user can see where the hole cup is actually located with respect to other features on the golf course. Although the user may be able to eyeball the location of the hole cup based on his observations through the scope 1002, the user can more confidently rely on the information displayed on the display 1004 and know that the hole cup is located near the front left side of the green, which neither a laser rangefinder nor a GPS device alone is able to provide to the user.

### Example Golf Device #3: Description

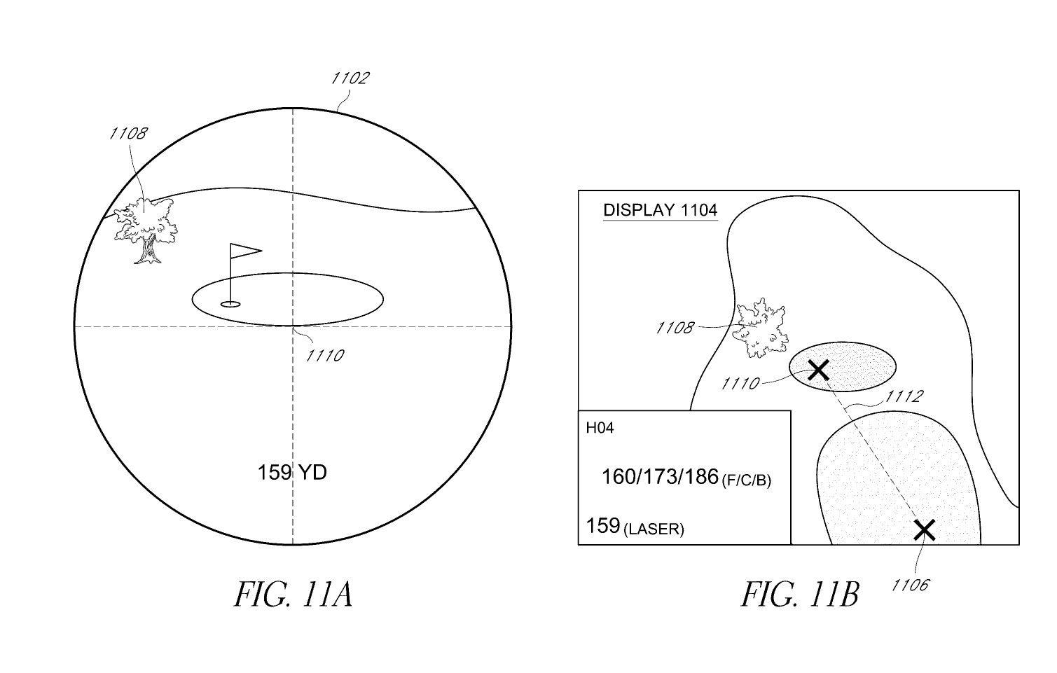

Turning to FIGS. 11A and 11B, an example method of displaying distance information is illustrated. FIG. 11A shows a scope 1102 of an example golf device, and FIG. 11B shows a display 1104 of the example golf device. As shown in FIG. 11A, the user has targeted the ground 1110 near the front edge of the green, and the distance from the user to the targeted ground is accordingly displayed at the bottom of the scope 1102 (e.g., 159 YD). The display 1104 shows the relative locations of the user and the ground targeted by the user (e.g., user location 1106 and ground location 1110). The location of the ground 1110 may be calculated using any of the techniques described herein (e.g., using the distance determined by the laser module, the direction determined by the orientation module, and the location of the golf device determined by the GPS module). The display 1104 also shows the tree 1108 and the direction 1112 in which the golf device is pointed at the ground 1110. The display 1104 also indicates the distances to the front, center, and back of the green, along with the distance to the ground targeted by the user.

### Example Golf Device #3: Advantage

In the example of FIGS. 11A and 11B, the user can see, in the display 1104, where the target ground is located with respect to other features on the golf course. Although the display 1104 displays the distance to the front of the green, the laser rangefinder feature may be used to confirm any information provided by the golf device 100.

### Example Golf Device #4: Description

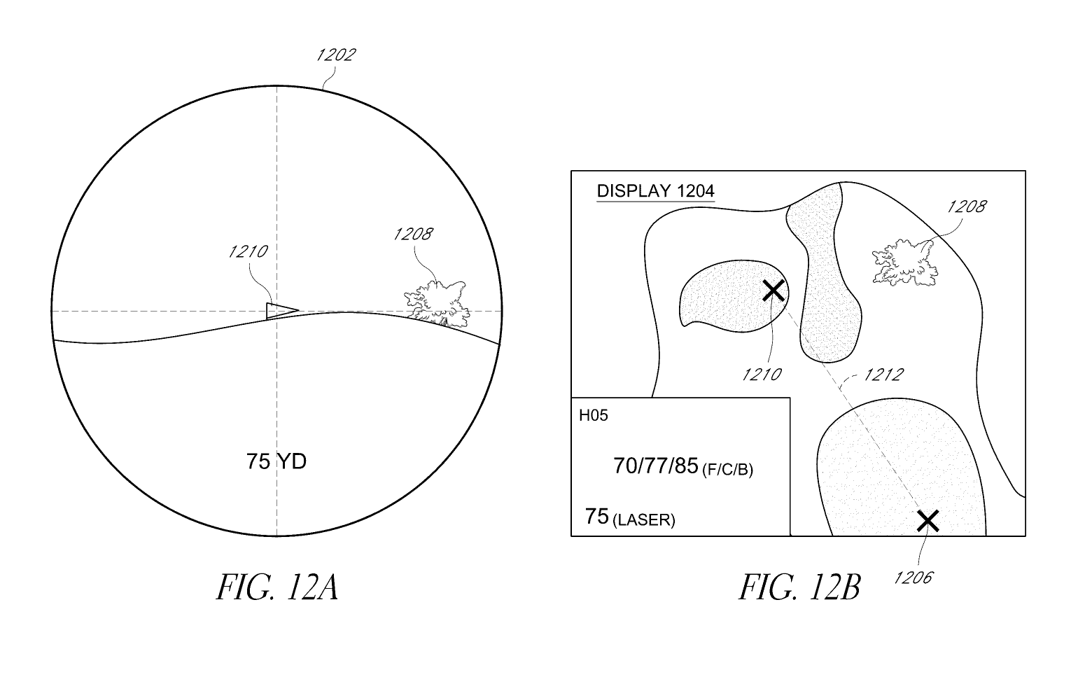

Turning to FIGS. 12A and 12B, an example method of displaying distance information is illustrated. FIG. 12A shows a scope 1202 of an example golf device, and FIG. 12B shows a display 1204 of the example golf device. As shown in FIG. 12A, the user has targeted the flag 1210 placed in the hole cup, and the distance from the user to the flag is accordingly displayed at the bottom of the scope 1202 (e.g., 75 YD). The display 1204 shows the relative locations of the user and the flag targeted by the user (e.g., user location 1206 and flag location 1210, respectively). The location of the flag 1210 may be calculated using any of the techniques described herein (e.g., using the distance determined by the laser module, the direction determined by the orientation module, and the location of the golf device determined by the GPS module). The display 1204 also shows the tree 1208 and the direction 1212 in which the golf device is pointed at the flag 1210. The display 1204 also indicates the distances to the front, center, and back of the green, along with the distance to the flag targeted by the user.

### Example Golf Device #4: Advantage

In the example of FIGS. 12A and 12B, the user's view of the green is limited, and the user can only see the flag and not the green itself. Looking at the flag as shown in FIG. 12A, the user may not have any idea where the hole cup might be located with respect to other features, such as the tree shown to the right of the flag. Without any further information, the user may decide to simply try to hit the ball towards the flag. As discussed above, in one embodiment, the golf device 100 displays the location of the flag on the map displayed in the display 1204, based on the distance to the target (e.g., 75 YD), the current location of the golf device 100 (e.g., user location 1206), and the orientation of the golf device 100 at the time the distance was measured (e.g., the direction 1212 shown in dotted line). Once the location of the flag has been plotted on the display 1204, the user can know where the flag is situated with respect to other features on the golf course. In the example of FIG. 12B, there is a hazard right next to the right edge of the green. Thus, it might be risky, especially for an amateur golfer, to simply aim the ball towards the flag. Depending on how good the user feels about this shot, he or she may aim the ball a little bit to the left of the flag so that the ball can make a safer landing on the green. With this additional visual information that shows how the hole cup situated with respect to other features on the golf course, the user may be able to further fine-tune his or her play strategy.

### Example Flowchart

FIG. 13 is a flowchart illustrating a method 1300 for determining a target position, according to an embodiment of the present disclosure. The steps illustrated in FIG. 13 may be performed by the golf device 400 of FIG. 1, or any components therein, or any other golf devices discussed herein or other devices (presently known or developed in the future) within the scope of the present disclosure. For convenience, method 1300 is described as performed by a golf device.

The method 1300 begins at block 1301. In block 1302, the golf device determines the location of the golf device. For example, as discussed above, the processing module 408 and/or the GPS module 402 of FIG. 4 may determine the location of the golf device 400 by processing GPS signals received from GPS satellites. The location of the golf device 400 may include GPS coordinates. In block 1304, the golf device 400 determines the distance to the target. For example, the target may be a visible object that is on the golf course and selected by the golfer. As discussed above, the laser module 404 and/or the processing module 408 of FIG. 4 may determine the distance to the target by using a laser beam. Although some example embodiments are described using a method of determining the distance using a laser beam, other distance-determining methods currently known or developed in the future may be used instead of or in conjunction with such embodiments. The distance determined by the golf device 400 may be the actual distance from the golf device 400 to the target. Alternatively, the distance determined by the golf device 400 may be a horizontal component (e.g., the component that is parallel to the surface of the earth) of the actual distance from the golf device 400 to the target. In block 1306, the golf device 400 determines the orientation of the golf device 400. As discussed above, the orientation module 406 and/or the processing module 408 of FIG. 4 may determine the orientation of the golf device 400. As discussed above, the orientation of the golf device 400 may be determined using an accelerometer and/or a compass. The orientation determined by the golf device 400 may include an angle of incline/decline and an azimuth angle. In another example, the orientation determined by the golf device 400 may include a 3-D vector. In yet another example, the orientation determined by the golf device 400 may include an angle between the azimuth angle and a reference direction (e.g., the magnetic north or any other predefined reference direction).

In block 1308, the golf device 400 determines the location of the target based on the collected information (e.g., location of the device, distance to the target, and orientation of the device). In some embodiments, the processing module 408 of FIG. 4 may determine the location of the target based on the information provided by the GPS module 402, laser module 404, orientation module 406, and/or any other components of the golf device 400. For example, the information determined in blocks 1302, 1304, and 1306 may include (i) the x-y coordinates of the device, (ii) the actual distance from the device to the target, and (iii) a combination of the angle of incline/decline and the azimuth angle representing the orientation of the device, respectively. In such an example, the processing module 408 may determine the horizontal component of the distance (“horizontal distance”) by multiplying the distance by the cosine of the angle of incline/decline. Further, the processing module 408 may determine the x-component of the horizontal distance by multiplying the horizontal distance by the cosine of the azimuth angle and the y-component of the horizontal distance by multiplying the horizontal distance by the sine of the azimuth angle. Then, the processing module 408 may add the x-component to the x-coordinate of the current location of the device and the y-component to the y-coordinate of the current location of the device. The resulting x-y coordinates would represent the location of the target. The techniques described herein may be extended to other forms of measurement (e.g., GPS coordinates instead of x-y coordinates, a 3-D vector instead of angles of incline/decline and azimuth, etc.). For example, in some embodiments, the golf device 400 determines the GPS coordinates of the target based on the collected information. In another embodiment, the golf device 400 determines the position of the target on the display based on the collected information. In block 1310, the golf device 400 causes an information display (e.g., display 410) to display the target on a plan view map representation of the hole or the golf course using the determined location of the target on the display. For example, the golf device 400 uses the determined GPS coordinates of the target to display a graphical representation of the target's location on the information display. A plan view is a horizontal display of 2-D data on the map, or a horizontal cross-section of 3-D data. A plan view of a hole on the map may include graphical representation of one or more features of the hole, including a contour of the boundary of a green, a contour of the boundary of a hazard, a contour of the boundary of a tee box, a contour of the boundary of fairway, a contour of the boundary of a cart path, a symbol or contour of objects such as large trees or rocks, or the shapes or contours of any other feature of the hole or the golf course.

In some embodiments, the graphical representation of the target's location relative to graphical representations of other features of the hole or the golf course is substantially representative of the target's location relative to such other features of the hole or the golf course. For example, the graphical representations may be “substantially representative” if the distances (e.g., distances in the plan view map representation) between the graphical representations are substantially proportional to the actual distances (e.g., distances on the plane parallel to the earth's surface) between the target and other features of the hole or the golf course. For example, the distances in the plan view map representation may be substantially proportional to the actual distances, if the ratios between two or more distances in the plan view map representation are each substantially equal (e.g., one value being within 0.1%, 0.5%, 1%, 2%, 3%, 4%, 5%, or 10% of the other value) to the corresponding ratios between two or more actual distances. In some embodiments, the target may be displayed (e.g., flag 1210) as illustrated in FIG. 12B. The method 1300 ends at block 1314.

Thus, by allowing the golfer to see where the hole cup is located with respect to other features on the golf course, the golf device allows the golfer to plan his or her shot with more complete information.

### Example Application of Target Position Determination

The method 1300 of FIG. 13 may be used in a variety of ways. For example, there may be situations when the golfer may not be able to take all of his clubs to the ball (e.g., the ball is too far from the cart path). In such situations, by providing the golfer with the distance from his or her ball (rather than from the current location of the golf device) to the hole cup, the golf device allows the golfer to know which club would be most desirable. Such a feature is especially helpful if the ball is far from the cart path and the golfer is limited to taking just two or three clubs to the ball location. Knowing ahead of time the distance from the ball to the hole cup before actually walking over to the ball, the golfer can bring the right club to the ball. In such an example, the golf device may determine the distance to the flag and the orientation (e.g., the direction that the golf device points to) of the golf device at the time it determines the distance to the flag. Then, the golf device determines the distance to the ball and the orientation of the golf device at the time it determines the distance to the ball. Based on the determined distances and the orientations (or angles), the golf device calculates the distance from the ball to the flag. The golf device may then indicate to the user how far the ball is from the flag. Knowing the distance from the ball to the flag, the user can know which club to bring to the ball (e.g., when the ball has landed far away from the cart path).

### Other Considerations

Although the embodiments of the inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, and that various changes in form and details may be made without departing from the spirit and scope of the present disclosure as set forth in the following claims.

What is claimed is:

1. A golf device comprising:
a GPS module configured to receive GPS signals for determining a location of the golf device;
a laser module configured to emit laser beams and detect reflections thereof from a target when the target is selected for determining a distance between the golf device and the target;
an orientation module configured to monitor movement of the golf device for determining an orientation of the golf device when the golf device aims the target and laser beams are emitted to the target;
an information display configured to display information thereon;
data stored in a memory and for use in displaying map representation of a plurality of golf courses on the information display; and
at least one processor configured to perform a method of:
determining the location of the golf device based on the GPS signals from the GPS module,
determining the distance between the golf device and the target based on the laser module's emission of laser beams to the target and detection of their reflections from the target,
determining the orientation of the golf device at the time of emission of laser beams to the target,
computing target location information indicative of a location of the target using each of the determined location of the golf device, the determined distance between the golf device and the target, and the determined orientation of the golf device, and
processing the target location information and at least part of the data stored in the memory to cause the information display to display the target's location on a plan view map representation of a hole comprising at least one feature such that the target's location relative to the at least one feature of the hole is graphically represented on the plan view map representation of the hole.

2. The device of claim 1, wherein the at least one feature in the plan view map representation of the hole comprises a boundary of a green of the hole, wherein the target comprises a pin of the hole, wherein the at least one processor is configured to cause the information display to display the location of the pin on the plan view map representation of the hole such that the pin's location relative to the boundary of the green is graphically represented on the plan view map representation and that distances between the pin's location and various points of the boundary of the green on the plan view map representation is generally proportionate to horizontal distances between the pin and various points of the boundary of the green.

3. The device of claim 1, wherein determining the location of the golf device comprises obtaining device location information indicative of the golf device at the time of emission of laser beams to the target, wherein the device location information is in a format for use in displaying the location of the golf device on the plan view map representation.

4. The device of claim 1, wherein the target location information indicative of the location of the target comprises at least one value for use in displaying the location of the target on the top plan view representation of hole, wherein determining the location of the golf device comprises computing at least one value for use in displaying the location of the golf device on the top plan view map representation of the hole.

5. The device of claim 1, further comprising a button for receiving a user's selection of the target, wherein the laser module is configured to emit laser beams when the button is pressed or touched.

6. The device of claim 1, wherein the orientation of the golf device corresponds to a direction in which the golf device is aimed at the target to emit the laser beams to the target, wherein determining the orientation of the golf device comprises computing at least one angular value of the direction relative to a reference direction.

7. The device of claim 6, wherein the at least one angular value comprises a horizontal angular value relative to the reference direction projected onto an imaginary horizontal plane that defines a plan view for the plan view map representation.

8. The device of claim 6, wherein the at least one angular value comprises a vertical angular value relative to an imaginary horizontal plane that defines a plan view for the plan view map representation.

9. The device of claim 1, wherein computing the target location information comprises determining at least one value representing the location of the target that is at the determined distance from the determined location of the golf device in a direction in which the device is aimed at the target in the determined orientation, wherein the at least one value represents the location of the target in a three-dimensional coordinate system.

10. The device of claim 1, wherein computing the target location information comprises determining at least one value representing the location of the target that is at the determined distance from the determined location of the golf device in a direction in which the device is aimed at the target in the determined orientation, wherein the at least one value represents the location of the target on an imaginary horizontal plane that defines a plan view of the plan view map representation.

11. A method of providing information on a golf device, the method comprising:
providing the golf device of claim 1;
emitting laser beams from the laser module to a visible target on a golf course in response to user selection of the visible target;
detecting reflections of at least part of the laser beams from the visible target;
determining a distance between the golf device and the visible target based on the laser module's emission of laser beams and detection of their reflections;
determining a location of the device based on GPS signals received at the GPS module of the device;
determining an orientation of the device at the time of emission of laser beams to the visible target;
computing target location information indicative of a location of the visible target using each of the determined location of the golf device, the determined distance between the golf device and the visible target, and the determined orientation of the golf device;
processing the target location information and at least part of the data stored in the memory of the golf device to display the visible target's location on a plan view map representation of a hole comprising at least one feature; and
displaying, on the information display, a plan view map representation of the hole such that the target's location relative to the at least one feature of the hole is graphically represented on the plan view map representation of the hole.

12. The method of claim 11, wherein the at least one feature in the plan view map representation of the hole comprises a boundary of a green of the hole, wherein the visible target comprises a pin of the hole, wherein the golf device displays the location of the pin on the plan view map representation of the hole such that the pin's location relative to the boundary of the green is graphically represented on the plan view map representation and that distances between the pin's location and various points of the boundary of the green on the plan view map representation is generally proportionate to horizontal distances between the pin and the various points of the boundary of the green.

13. The method of claim 11, wherein determining the location of the golf device comprises obtaining device location information indicative of the golf device at the time of emission of laser beams to the target, wherein the device location information is in a format for use in displaying the location of the golf device on the plan view map representation.

14. The method of claim 11, wherein the target location information indicative of the location of the visible target comprises at least one value for use in displaying the location of the target on the top plan view representation of hole, wherein determining the location of the golf device comprises computing at least one value for use in displaying the location of the golf device on the top plan view map representation of the hole.

15. The method of claim 11, wherein the orientation of the golf device corresponds to a direction in which the golf device is aimed at the visible target to emit the laser beams to the visible target, wherein determining the orientation of the golf device comprises computing at least one angular value of the direction relative to a predetermined reference direction.

16. The method of claim 15, wherein the at least one angular value comprises a horizontal angular value relative to the reference direction projected onto an imaginary horizontal plane that defines a plan view for the plan view map representation.

17. The method of claim 15, wherein the at least one angular value comprises a vertical angular value relative to an imaginary horizontal perpendicular that defines a plan view for the plan view map representation.

18. The method of claim 11, wherein computing the target location information comprises determining at least one value representing the location of the target that is at the determined distance from the determined location of the golf device in a direction in which the device is aimed at the target in the determined orientation, wherein the at least one value represents the location of the target in a three-dimensional coordinate system.

19. The method of claim 11, wherein computing the target location information comprises determining at least one value representing the location of the target that is at the determined distance from the determined location of the golf device in a direction in which the device is aimed at the target in the determined orientation, wherein the at least one value represents the location of the target on an imaginary horizontal plane that defines a plan view of the plan view map representation.
